(19) United States
(12) Patent Application Publication
(10) Pub. No.: US 2010/0333013 A1
(43) Pub. Date: Dec. 30, 2010

(54) Method of Managing the Display of a Window of an Application on a First Screen, a Program, and a Terminal using it

(75) Inventors: Mehdi Ouchia, Landivisiau (FR); Maryline Lebouc, Lannion (FR)

Correspondence Address: COHEN, PONTANI, LIEBERMAN & PAVANE LLP, 551 FIFTH AVENUE, SUITE 1210, NEW YORK, NY, 10176, US

(73) Assignee: France Telecom, Paris (FR)

(21) Appl. No.: 12/825,028

(22) Filed: Jun. 28, 2010

(30) Foreign Application Priority Data
Jun. 26, 2009 (FR) 09 54368

(51) Int. Cl. G06F 3/048

(52) U.S. Cl. 715/781

(57) ABSTRACT

A method of managing a window of an application displayed on a first screen, a program, and a terminal using it. In particular, the terminal is an interactive table. The method includes the determination of a first parameter about the display of the window as a function of a second parameter about an activation element on activation of the application by the activation element.

### RELATED APPLICATIONS

This application claims the priority of French application no. 09/54368 filed Jun. 26, 2008, the entire content of which is hereby incorporated by reference.

### FIELD OF THE INVENTION

The invention relates to a method of managing the display of a window of an application on a first screen, to a program, and to a terminal using it. In particular, the terminal is an interactive table.

### BACKGROUND OF THE INVENTION

In the context of a user interface that is available on a horizontally placed screen such as an interactive table, it proves difficult to presume the position of the user around this screen and to manage the orientation of the display correctly.

A first solution that has been envisaged is to divide the screen into a plurality of areas: when the screen is rectangular by dividing the screen into two rectangles lengthwise, for example, the bases of the rectangles being the long edges of the screen. Thus all the data displayed is oriented relative to the base of the rectangular area in which it is displayed.

That solution is beneficial when the table always has the same number of users (two users in the present situation). If a user is alone at such an interface, that user can use only half of it, because the orientation of the other half is not suitable.

US patent application US2007 0157095 proposes an interface enabling users to select areas of a screen that they wish to reorient at their convenience, and providing them with orientation tools for redefining the orientation of said areas dynamically afterwards.

Depending on the position of a user relative to the table and the predefined orientation of the displayed data, that solution may prove burdensome because each time that the user wishes to display new data, that data must be selected and reoriented.

### OBJECT AND SUMMARY OF THE INVENTION

One of the objects of the present invention is to remedy the drawbacks of the prior art.

One aspect of the invention is directed to a method of managing the display of a window of an application on a first screen, including determining a first parameter about the display of said window as a function of a second parameter about an activation element on activation of said application by means of said activation element.

Thus by modifying only the activator element, a user may define at least one parameter for displaying all the application windows that will be opened afterwards using that element.

Advantageously, the first parameter about the display of said window and the second parameter about said activation element relate respectively to an orientation of said window relative to said first screen and an orientation of said activation element relative to a reference area.

Thus the orientation parameter of future application windows is easily defined simply by changing the orientation of the activation element, for example the mouse.

Advantageously, said reference area consists of said first screen and said second parameter relates to an orientation of the displayed activation element relative to said first screen.

Accordingly, on an interactive table, the application windows always open in the same direction as the menu and/or the matrix of icons.

Advantageously, said activation element is a circular menu that may be re-oriented through 360°.

Thus the menu is easier to reorient because it is not necessary for the menu to be parallel to the edge of the screen to determine an orientation of the windows.

Advantageously, the steps of the method of one implementation of the invention are executed by software or a computer program, the software including software instructions adapted to be executed by a data processor of a device that is part of a terminal and designed to control the execution of the steps of the method.

Another aspect of the invention relates to a program including program code instructions for executing the steps of a management method as described above when said program is executed by a processor.

This program may use any programming language and take the form of source code, object code, or a code intermediate between source code and object code, such as a partially-compiled form, or any other desirable form.

Another aspect of the invention relates to an information medium storing a computer program as described above.

The information medium may be any entity or device capable of storing the program. For example, the medium may include storage means, such as a read only memory (ROM), for example a CD ROM or a micro-electronic circuit ROM, or magnetic storage means, for example a diskette or a hard disk.

Moreover, the information medium may be a transmissible medium such as an electrical or optical signal, which may be routed via an electrical or optical cable, by radio, or by other means. The program of the invention may in particular be downloaded over an Internet-type network.

Alternatively, the information medium may be an integrated circuit in which the program is incorporated, the circuit being adapted to execute the method in question or to be used in its execution.

A different implementation of the invention is performed by means of software and/or hardware components. In this situation the term “module” refers either to a software component or to a hardware component.

A software component is one or more computer programs, one or more subroutines of a program, or more generally any program or software element able to implement a function or a set of functions as described below. A hardware component is any element of a hardware set able to implement a function or a set of functions.

Another aspect of the invention relates to a device for managing display of an application window on a first screen including means for determining a first parameter about the display of said window as a function of a second parameter about an activation element on activation of said application by means of said activation element.

Another aspect of the invention relates to a terminal including a first screen and means for determining a first parameter about the display of a window as a function of a second parameter about an activation element on activation of said application by means of said activation element.

Said first screen is advantageously a touch-sensitive screen.

The terminal is advantageously an interactive table.

### BRIEF DESCRIPTION OF THE DRAWINGS

FIG. 1 shows a block diagram illustrating a method according to an embodiment of the invention for managing the display of a window of an application on a first screen;

FIG. 2 shows an interactive terminal using a device according to an embodiment of the invention for managing the display of a window of an application on a first screen;

FIGS. 3a to 3e show an application window opening scenario using a method according to an embodiment of the invention when the first and second parameters are orientation parameters;

FIGS. 4a to 4e show an application window opening scenario using a method according to an embodiment of the invention when the first and second parameters are position parameters;

FIGS. 5a to 5e show an application window opening scenario using a method according to an embodiment of the invention when the first and second parameters are style parameters.

### DETAILED DESCRIPTION OF THE DRAWINGS

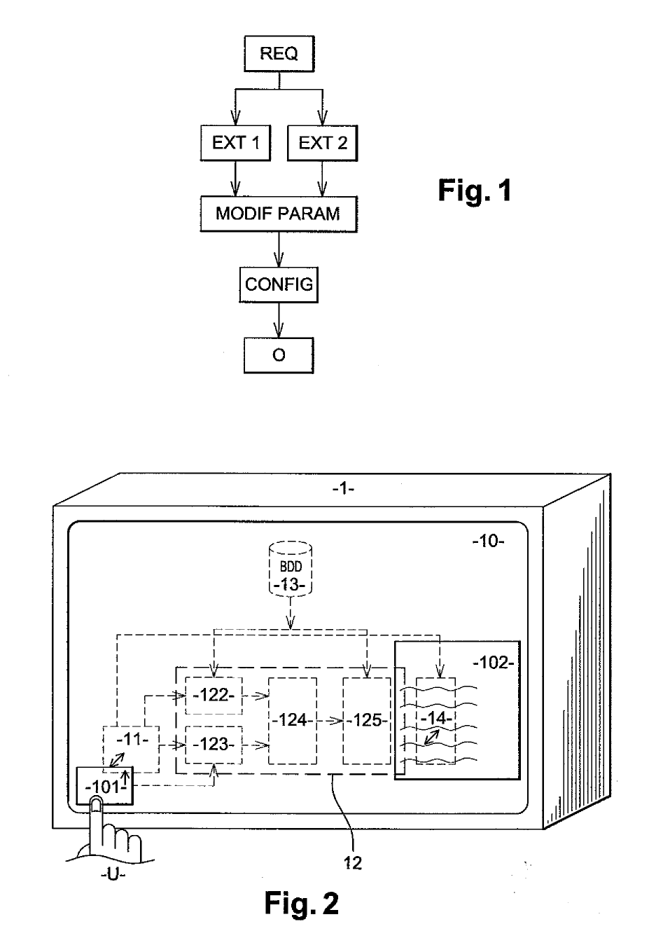

The first part of the description with reference to FIGS. 1 and 2 relates to an interactive table for which the activation element is a menu listing a series of available applications, the first and second parameters respectively relating to the orientation on the screen of the interactive table of a window of an application such as a photo album, a video on demand (VOD) catalog, etc., and the menu.

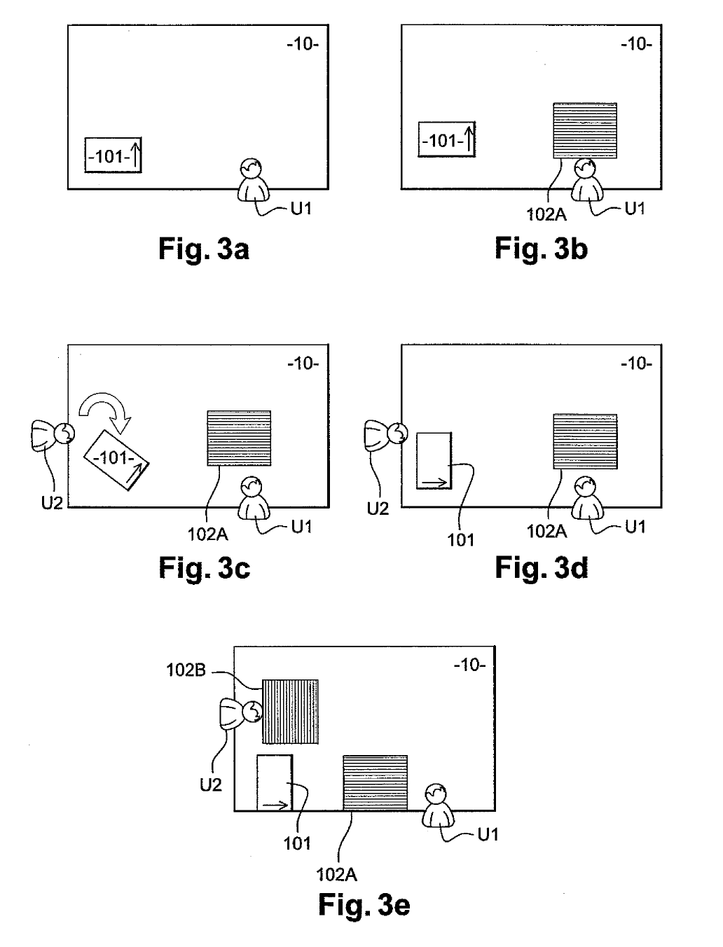

This description is not limiting on the invention, as the scenario examples of FIGS. 3a-3e, 4a-4e, and 5a-5e show. The activation element may equally well be a menu, an icon displayed on the first screen or a second screen, or an activation device such as a mouse, an interactive stylus, etc. Furthermore, the first parameter about the display of the application window may equally well be a display orientation, position, style, etc. parameter and the second parameter about the activation element may equally well be an orientation, position, style, type, etc. parameter. Also, the application is any type of application requiring a display on a screen: word processing, photo album, television, VOD catalog, computer-assisted design (CAD), etc. Moreover, the device of the invention is used in any type of terminal having a screen for displaying a window of an application at the request of a user via an activation element.

The various implementations described may be performed separately or in combination.

FIG. 1 illustrates the method of managing the display of a window of an application on a first screen. The method includes a step (MODIF PARAM) of determining a first parameter about the display of said window as a function of a second parameter about an activation element on activation of said application by means of said activation element.

In a particular implementation of the invention, before determining this parameter, a first parameter is extracted (ExT1), notably from a configuration database that may be specific to said application. Determining the first parameter then consists, where appropriate, in modifying this first parameter as a function of a second parameter about an activation element on activating said application by means of said activation element.

In a particular implementation of the invention, before determining the first parameter, the second parameter is extracted (ExT2), notably from a configuration database that may be specific to said activation element or from an activation request sent by said activation element to trigger the opening of a window of said application or by detection of said second parameter.

In a particular implementation of the invention, said activation element sends an activation request REQ to trigger the opening O of a window of said application that leads to determination of a first parameter (MODIF PARAM) and before this, where appropriate, extraction (ExT1, ExT2) of the first and second parameters.

In a particular implementation of the invention, the display configuration of said window of said application is modified (CONFIG) to take account of the first parameter determined in this way.

In a particular implementation of the invention, the opening O of the window of said application takes account of the first parameter determined in this way.

FIG. 2 shows a terminal 1 using a device 12 of the invention for managing the display of a window of an application. The terminal 1 includes a first screen 10 displaying an activation element 101 and a window 102 of an application. The management device 12 includes means 124 for determining a first parameter about the display of said window 102 as a function of a second parameter about an activation element 101 on activation of said application by means of said activation element 101. Accordingly, said application window 102 is displayed taking account of the first parameter determined by the determination means 124.

In a particular implementation of the invention (not shown), the terminal 1 includes the determination means 124 directly and does not include a management device 12.

In a particular implementation of the invention, the screen 10 is a touch-sensitive screen and the activation element 101 is a menu or an icon by means of which the user U activates the application by touch alone.

In a particular implementation of the invention, the terminal includes 11 means for activating an application associated with the application element 101. Said activation means 11 are triggered via said activation element 101, i.e. by touching the area of the screen 10 displaying the activation element 101 in the example of a touch-sensitive screen.

In a particular implementation of the invention, the terminal 1 includes means 123 for extracting the second parameter. The extraction means 123 are notably controlled by the activation means 11. The extraction means 123 shown in FIG. 2 detect the second parameter used by the activation element 101 displayed on the screen 10. In implementations of the invention that are not shown, the extraction means 123 extract the second parameter from the activation request sent by the activation element 101 to the activation means 11 or from a configuration database that may be specific to the activation element.

In a particular implementation of the invention, the terminal 1 includes means 122 for extracting the first parameter by default. The extraction means 122 notably look up the first parameter in a configuration database 13 that may be specific to the applications or even to the activated application.

In a variant of the invention the terminal 1 includes extraction means (not shown) adapted to extract the first and second parameters at the same time.

In a particular implementation of the invention, the terminal 1 includes means 125 for updating the configuration. These updating means 125 receive from the determination means 124 the first parameter determined as a function of the second parameter on activation of the application.

In a particular implementation of the invention, the updating means 125 extract the configuration parameters for the application window from a configuration database 13 possibly specifically to the applications or even to the activated application. These configuration parameters are either default parameters or customized parameters.

In a particular implementation of the invention, when the configuration parameters have been updated with the received second parameter, the updating means 125 store the updated parameters in the database 13.

Depending on the implementation of the invention, the management device 12 may include one or more of the following means in addition to the means 124 for determining the second parameter:
the means 122 for extracting the first parameter;
the means 123 for extracting the second parameter;
the means 125 for updating the configuration;
the database 13.

In a particular implementation of the invention, the terminal includes display means 14 for displaying a window of an application. Said display means 14 use configuration parameters including the first parameter determined by the determination means 124 to display the window 102.

In a particular implementation of the invention, the display means 14 receive the configuration parameters from the means 125 for updating the display management device 12.

In an alternative, not shown, the display means look up the configuration parameters in the database 13 after updating with the first parameter determined by determination means 124.

In another alternative, not shown, the display means receive the first parameter determined by the determination means 124 and look up the other parameters in the database 13. Reception of the first parameter determined by the determination means 124 may trigger looking up of the other parameters by the display means 14 or sending of those other parameters by the database 13 at the request of the determination means 124 or the activation means 11.

In an implementation of the invention that is not shown, the activation means 11 trigger the display of the window 102 by the display means 14 which first initiate determination by the determination means 124 of the first parameter and initiate the display on receiving the first parameter determined in this way.

Accordingly, the activation means 11 and/or the display means 14 and/or the database 13 and/or the management device 12 and/or in particular the determination means 124 and/or the extraction means 122 and/or the extraction means 123 and/or the updating means 125 are used for all applications implemented on the terminal 1 or for specific applications for which a link has been effected beforehand with the activation element 101 or are specific to one application (in which situation there are multiple means of this kind for all applications for which a link is required by the application creator and/or the terminal manufacturer and/or the user).

FIGS. 3a to 3e illustrate a scenario of use of the invention in order to explain more clearly the steps of the display management method. In this scenario, the terminal 1 is an interactive table consisting of a screen 10, notably a touch-sensitive screen, the first parameter is the orientation relative to the screen 10 of the displayed window 102, and the second parameter is the orientation relative to the screen 10 of the displayed activation element 101, for example a menu.

To use the interactive table a first user U1 stands facing one of the longer lengthwise sides of the screen 10. The menu 101 is already oriented to face this side of the screen 10 (i.e. to face the first user U1), and the user U1 manipulates the menu 101 to activate an application, notably a photo album, as FIG. 3a shows.

The management device of the invention determines the orientation of the display of the window 102a of the photo album as a function of the orientation of the menu 101 relative to the screen 10. Here the orientation of the display of the window 102A is identical to that of the menu 101 relative to the screen 10. Accordingly, the photo album 102A is opened facing the user U1, as FIG. 3b shows.

To use the interactive table a second user U2 stands facing one of the shorter widthwise sides of the screen 10. As the menu 101 is difficult for this user to read, they change its orientation so that it faces this widthwise side of the screen 10 (i.e. faces the second user U2), as the arrow in FIG. 3c shows.

Once the menu 101 has been reoriented, the user U2 uses the menu 101 to activate an application, notably a video on demand (VOD) catalog, as FIG. 3d shows.

The management device of the invention determines the orientation of the display of the window 102B of the VOD catalog as a function of the orientation of the menu 101 relative to the screen 10. The orientation of the display of the window 102B relative to the screen 10 is identical to that of the menu 101. Accordingly, as FIG. 3e shows, the VOD catalog 102B is opened facing the user U2 without modifying the orientation of the photo album 102A consulted by the user U1.

In a particular implementation of the invention, the menu 101 is a circular menu that may be reoriented through 360° and the first orientation parameter is notably not equal to the exact angular orientation of the menu 101 relative to the screen 10 but only to its polar orientation (north, south, east, west of the table for a square or rectangular screen, plus north-east, north-west, south-west, south-east for an octagonal screen, etc.). Thus if the screen 10 has sides as shown by FIGS. 3a to 3e, the windows 102 are always opened with their base parallel to the side of the screen forming the base for the user U who activated the application even if the user has roughly oriented the menu 101 to face them.

In a variant usage, such as an interactive desk, the first orientation parameter of the display of the predetermined application window is, as a function of the application, equal either to the orientation parameter of the menu or to the opposite of the orientation parameter of the menu, notably for applications such as a pupil working in an exercise book that will be shown the right way up to a teacher facing them who manipulates the menu to face the pupil, whereas the correction application faces the teacher.

In a particular implementation of the invention, activation of the application is requested from a second screen that may belong to the interactive terminal, for example a touch-sensitive mobile terminal (PDA, mobile telephone) enabling applications to be remote-controlled on an interactive board via an IR, Bluetooth or WiFi link, for example. On the screen of this mobile terminal, an application window for interacting with the interactive board constitutes a reference area in which is displayed either a menu or a matrix of icons of the applications available on the interactive board. The display orientation of the application window 102 is then determined either as a function of the position relative to the first screen 10 of the mobile terminal, which then constitutes the activation element 101, or as a function of the orientation relative to the reference area of the menu or the matrix of icons, which then constitutes the activation element 101.

In a variant of the invention, the reference area is part of the screen 10.

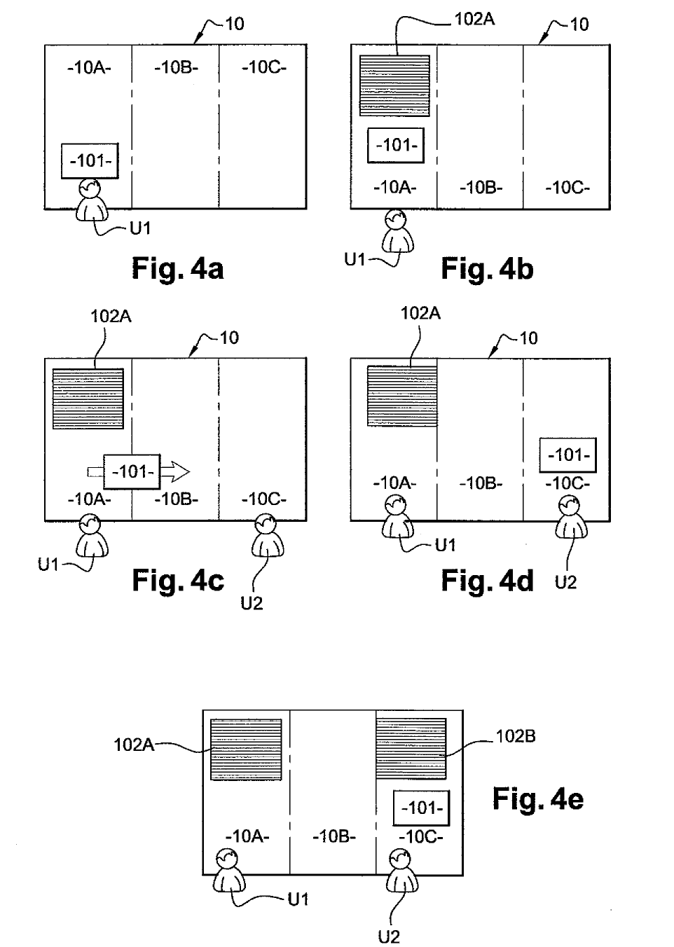

In order to explain more clearly the steps of the display management method, FIGS. 4a to 4e illustrate a scenario of use of the invention. In this scenario, the terminal 1 is an interactive board consisting of a screen 10, the first parameter is the position relative to the screen 10 of the displayed window 102, and the second parameter is the position relative to the screen 10 of the activation element 101, which is an interactive stylus, for example.

To use the interactive board a first user U1 faces a lengthwise side 10A of the screen 10 and uses the stylus 101 to activate an application, notably a photo album, as FIG. 4a shows.

The management device of the invention determines the position of the displayed photo album window 102A as a function of position relative to the screen 10 of the stylus 101. Here, the displayed window 102A is in the same part 10A of the screen 10 that the stylus 101 is facing. Thus the photo album 102A is opened facing the user U1, as FIG. 4b shows.

A second user U2 facing another part 10c of the screen 10 picks up the stylus 101 in order to use the interactive board. The stylus 101 then changes position relative to the screen 10, as the arrow in FIG. 4c shows.

Once the user U2 has picked up the stylus 101 (which is therefore positioned in front of the same part 10C of the screen 10 as the user U2), they manipulate the stylus 101 to activate an application, notably a video on demand (VOD) catalog, as FIG. 4d shows.

The management device of the invention determines the position of the displayed window 102B of the VOD catalog as a function of the position relative to the screen 10 of the stylus 101. The position of the displayed window 102B is identical to the position relative to the screen 10 of the stylus 101. Accordingly, as FIG. 4e shows, the VOD catalog 102B is opened facing the user U2 without modifying the position of the photo album 102A consulted by the user U1.

In a variant of the invention, the user U1 uses a first stylus 101₁ and the user U2 uses a second stylus 101₂. The application 102A is opened by the first user U1 in the part 10A of the screen facing the first stylus 101₁ used by the first user U1 and the application 102B is then opened by the second user U2 in the part 10C of the screen facing the second stylus 101₂ used by the second user U2.

In a variant of the invention, the user U1 takes up a position in front of the interactive board after opening a first application 102A and, facing a second part 10C of the board, uses the stylus 101 to open a second application 102B. The second application 102B is opened facing the user U1 without modifying the first application 102A previously opened by the user U1.

In a particular implementation (not shown), the stylus 101 is replaced by a mouse 101 manipulated on a horizontal support. The second parameter is then the position of the mouse relative to a reference area on this support. This reference area on this support may be defined once and for all or when the interactive board is started up, and the position of the mouse on a horizontal support is defined as associated with the point in the bottom left-hand corner of the screen 10 of the interactive board. In this second example, the horizontal support could consist of a plurality of tables facing the interactive board and those involved could remain seated at their table and simply use the mouse to open an application on the respective part 10A, 10B, 10C facing them.

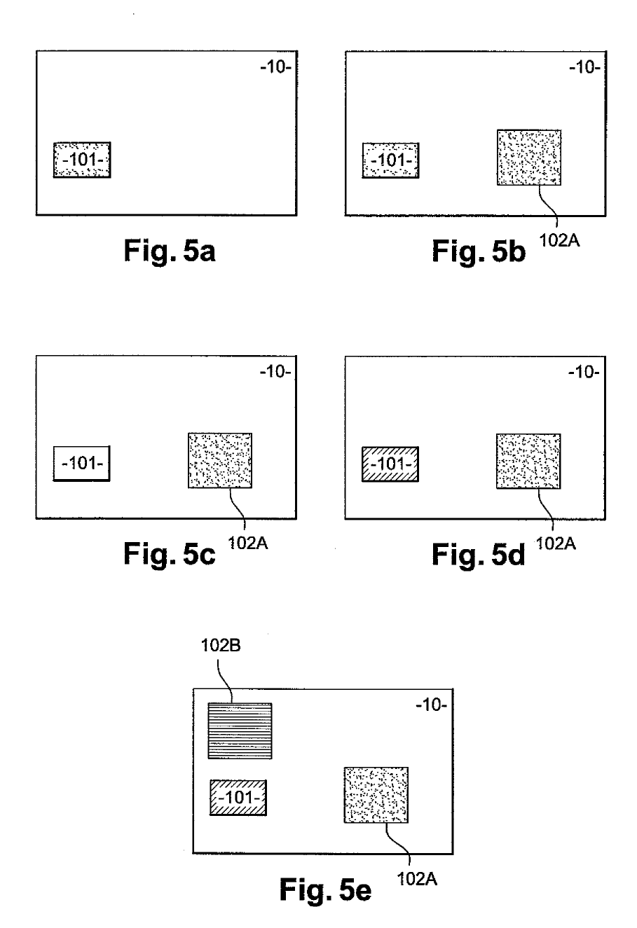

In order to explain more clearly the steps of the display management method, FIGS. 5a to 5e illustrate a scenario of use of the invention. In this scenario, the terminal 1 is an interactive terminal consisting of a screen 10, notably a touch-sensitive screen, the first parameter is a parameter of the style of the window 102 displayed on the screen 10, and the second parameter is a parameter of the style of the activation element 101, for example a menu, displayed on the screen 10.

If the first user U1 decides to use the interactive terminal, the menu 101 being already configured for them, the user U1 manipulates the menu 101 to activate an application, notably a photo album, as FIG. 5a shows.

The management device of the invention determines the style of the displayed window 102A of the photo album as a function of the style of the menu 101 relative to the screen 10. Here, the style of the displayed window 102A is the style associated with the style of the menu 101 in a style database. Accordingly, as FIG. 5b shows, the photo album 102A is opened in a style customized for the user U1.

If the second user U2 decides to use the interactive terminal, because the style of the menu 101 does not suit them (notably because the font is too large), they change it, as FIG. 5c shows, for example by pointing on the menu 101 to their personal configuration, for example by choosing “So and so's menu” in a list of personalized menus or in this example to change the font size.

Once the style of the menu 101 has been modified, the user U2 manipulates the menu 101 to activate an application, notably a video on demand (VOD) catalog, as FIG. 5d shows.

The management device of the invention determines the style of the displayed window 102B of the VOD catalog as a function of the style of the menu 101. The style of the displayed window 102B is the style associated in a database with the style of the menu 101. Accordingly, as FIG. 5e shows, the VOD catalog 102B is opened in the style specific to the user U2 without modifying the style of the photo album 102A consulted by the user U1.

In a variant of the invention, the style is the color of the frame of the application window 102, enabling each of the users U1 and U2 to recognize easily the applications that they have opened.

In a particular implementation of the invention, a plurality of first display parameters of the application window 102 is determined as a function of one parameter only of the activation element 101, notably the orientation and the color of the frames of the windows as a function of the orientation of the matrix 101 of icons.

What is claimed is:

1. A management method of managing the display of a window of an application on a first screen, wherein the method includes determination of a first parameter about the display of the window as a function of a second parameter about an activation element on activation of the application by the activation element.

2. The management method according to claim 1, wherein the first parameter about the display of the window and the second parameter about the activation element respectively relate to an orientation of the window relative to the first screen and an orientation of the activation element relative to a reference area.

3. The management method according to claim 1, wherein said reference area consists of said first screen and said second parameter relates to an orientation of the displayed activation element relative to said first screen.

4. The management method according to claim 1, wherein said activation element is a circular menu that may be re-oriented through 360°.

5. A program comprising program code instructions for executing the step of the management method according to claim 1 when said program is executed by a processor.

6. An information medium storing a program according to claim 5.

7. A management device for managing display of an application window on a first screen, wherein the management device includes means for determining a first parameter about the display of the window as a function of a second parameter about an activation element on activation of the application by means of the activation element.

8. A terminal including a first screen and means for determining a first parameter about display of a window as a function of a second parameter about an activation element on activation of the application by means of the activation element.

9. The terminal according to claim 8, wherein said first screen is a touch-sensitive screen.

10. A terminal according to claim 8, wherein said terminal is an interactive table.
